(19) United States
(12) Patent Application Publication
(10) Pub. No.: US 2008/0038500 A1
(43) Pub. Date: Feb. 14, 2008

(54) Stretch-blow molded polypropylene article

(76) Inventors: Richard D. Page, Boiling Springs, SC (US); Brian C. Miller, Spartanburg, SC (US); Shawn R. Sheppard, Boiling Springs, SC (US)

Correspondence Address: Legal Department (M-495), P.O. Box 1926, Spartanburg, SC, 29304, US

(21) Appl. No.: 11/701,724

(22) Filed: Feb. 2, 2007

Related U.S. Application Data
(60) Provisional application No. 60/774,010, filed on Feb. 16, 2006.

(51) Int. Cl. B29C 35/08; B28B 17/02; B29D 22/00; B29C 35/02

(52) U.S. Cl. 428/36.92; 264/402; 264/535; 425/174.4

(57) ABSTRACT

The invention relates to a process for producing polypropylene bottles comprising, forming a polypropylene preform by injection molding, cooling the polypropylene preform to ambient temperature, preheating the preform article, wherein the temperature around the circumference of the preform article has a temperature delta of less than 5 degrees Celsius at any height along the preform, inserting the preheated preform into a cavity of a stretch blow molding machine, and stretch blow molding the preform into a polypropylene bottle at a rate of at least 1000 bottles per cavity per hour, wherein the polypropylene bottle has a wall thickness delta at any given height along the bottle of less than 30% of the average wall thickness at the given height. The invention also relates to the polypropylene bottle made from this process.

### CROSS REFERENCE TO RELATED APPLICATIONS

This application claims priority to U.S. Provisional Patent Application Ser. No. 60/774,010, filed on Feb. 16, 2006, which is herein incorporated by reference in its entirety.

### TECHNICAL FIELD

This invention relates to a process to produce polypropylene bottles at high rates of production and with a small circumferential thickness variation at any height along the bottle and the bottles made from this process.

### BACKGROUND

Injection stretch blow molding is a process of producing thermoplastic articles, such as liquid containers. This process involves the initial production of a preform article by injection molding. Then, the preform article is reheated and subjected to stretching and gas pressure to expand (blow) the preform article against a mold surface to form a container.

There are several different processes that employ stretch blow molding. A first type is a single stage process in which a preform is made on a machine and allowed to cool somewhat to a predetermined blow molding temperature. While still at this elevated temperature, the preform is stretch blow molded into a container on the same machine, as part of a single manufacturing procedure. This is a one step or so-called “single stage” manufacturing procedure. In a typical single stage blow molding process for polypropylene, the temperature of the preform is cooled (reduced) following preform formation from about 230° C. to about 120-140° C. The preform is not returned to ambient temperature, but instead is blown to a container while at about 120 to 140° C.

Another type of process is a two stage process. In a two stage process, preforms first are formed in an injection machine. Then, preforms are cooled to ambient temperature. In some cases, preforms are shipped from one location to another (or from one company to another) prior to stretch blowing the preforms into containers. In the second stage of the two-stage process, preforms are heated from an initial ambient temperature to an elevated temperature for stretch blowing on a molding machine to form a container. The injection machine and the molding machine typically are located apart from one another in such a two stage procedure. Two stage manufacturing processes are sometimes referred to as “reheat stretch blow molding” (RSBM) processes, because preform articles formed in the first stage are subsequently reheated during the second stage of manufacture to form finished containers.

Two stage container manufacture is comprised of: (1) injection and cooling of a preform to ambient temperature, followed by (2) stretch blow molding to form a container. Two stage manufacturing reveals certain advantages over single stage processes. For example, preform articles are smaller and more compact than containers. Therefore, it is easier and less costly to transport large numbers of preform articles, as compared to transporting large numbers of containers. This fact encourages producers to make preform articles in one location, and manufacture containers in a second location, reducing overall production costs. Thus, one advantage of two stage container manufacture is that it facilitates separate optimization of each stage of manufacturing. Furthermore, it is recognized that the two stage process is more productive and provides more opportunities for cost savings for large volume applications.

It is common, therefore, for a two-stage process to be used in applications for which large volumes of containers are to be made. Thus, a preform may be shipped to a location at which the finished containers will be employed in the marketplace. Then, in that instance, actual shipping costs for completed containers will be greatly reduced. The explanation for this is that the shipping costs for fully blown containers are significantly greater than shipping costs for preforms, which are much smaller and more compact. Thus, two-stage processes are used commonly for large volume product applications such as drink bottles, soda bottles, water bottles and the like. On the other hand, it is common in the industry for one stage processes to be used for bottles which are used commercially in much smaller volumes.

Stretch blown thermoplastic articles formed of polyethylene terephthalate (PET) are common in the industry. Such polyesters provide highly transparent and aesthetically pleasing container articles. PET bottle production has enjoyed tremendous success in the last twenty years. However, there is a continuing drive in the industry to reduce costs while still providing containers of suitable quality and clarity. Overall production cost for containers is a function of many factors, including raw material cost and also manufacturing speed or efficiency.

In the industry, it is known to make containers from polypropylene. Polypropylene in general is a lower cost raw material as compared to PET. However, polypropylene has not significantly replaced PET as the material of choice for drink bottle manufacturing. One reason that polypropylene has not replaced PET as the material of choice, given its lower overall raw material costs, is that the injection and blow molding cycle time for polypropylene has been excessively long and in some cases much less stable than a PET process. Long cycle times and reduced process reliability drive up the cost for using polypropylene as compared to PET for container manufacture.

There is a need in the industry for a process of making polypropylene containers on existing PET manufacturing equipment that is already deployed in the industry. Currently known methods of injection stretch blow molding PET preforms have generally not been successfully employed for polypropylene container manufacture.

### SUMMARY

The invention relates to a process for producing polypropylene bottles comprising, forming a polypropylene preform by injection molding, cooling the polypropylene preform (preferably to ambient temperature), preheating the preform article, wherein the temperature delta, defined as the highest and lowest temperature measured around the circumference (360°) of the preform article at an orientable height (meaning a height where the bottle is oriented, typically the entire preform except for the screw top area) is no more than 10° C., more preferably 5° C., more preferably 3 degrees, more preferably 2° C., and even more preferably 1° C. as measured by a suitable measuring device. In some applications, it has been found to be useful to measure the temperature delta by using an infrared imaging camera. Next, the preheated preform is inserted into a cavity of a stretch blow molding machine, and stretch blow molding the preform into a polypropylene bottle at a rate of at least about 1000 bottles per cavity per hour, wherein the polypropylene bottle has a wall thickness delta at any given height along the bottle of less than 30% of the average wall thickness at the given height. The invention also relates to the improved polypropylene bottle made from this process.

### BRIEF DESCRIPTION OF THE DRAWINGS

An embodiment of the present invention will now be described by way of example, with reference to the accompanying drawings.

FIG. 1 shows a schematic of a polypropylene preform;

FIG. 2A shows a front piece of a typical reflector for the preheat section of the stretch-blow molding machine;

FIG. 2B shows a the back piece of a typical reflector for the preheat section of the stretch-blow molding machine;

FIG. 2C shows images of partially expanded (preblow) polypropylene bottles using the reflector shown in FIG. 2A;

FIG. 2D shows images of fully expanded polypropylene bottles using the reflector shown in FIG. 2A;

FIG. 3A shows the front piece of one embodiment of a reflector of the invention for the preheat section of the stretch-blow molding machine;

FIG. 3B shows the back piece of one embodiment of a reflector of the invention for the preheat section of the stretch-blow molding machine;

FIG. 3C shows images of partially expanded (preblow) polypropylene bottles using the reflector shown in FIG. 3A;

FIG. 3D shows images of fully expanded polypropylene bottles using the reflector shown in FIG. 3A;

FIG. 4A is a chart showing the thickness delta of formed 500 ml polypropylene bottles using different reflectors in the preheat section versus height of the bottle;

FIG. 4B is a chart showing the thickness delta as a percentage of average wall thickness of formed 500 ml polypropylene bottles using different reflectors in the preheat section versus height of the bottle;

FIG. 5A is a chart showing the thickness delta of formed 12 ounce (354.9 ml) polypropylene bottles using different reflectors in the preheat section versus height of the bottle;

FIG. 5B is a chart showing the thickness delta as a percentage of average wall thickness of formed 12 ounce (354.9 ml) polypropylene bottles using different reflectors in the preheat section versus height of the bottle;

FIG. 6, shows images of temperature variation on the preforms with the reflector of FIGS. 2A-B and the reflector of FIGS. 3A-B.

FIG. 7 shows an illustration of Comparison Example 3 heat distribution.

FIG. 8 shows an illustration of Invention Example 4 heat distribution.

### DETAILED DESCRIPTION

This invention relates to a process to produce polypropylene bottles at high rates of production and a small circumferential thickness variation at any height along the bottle and the bottles made from this process. The bottles produced by the inventive process have a more ideal distribution of polypropylene material in the circumferential direction, which is advantageous for several reasons.

The first advantage is that container specifications often depend, in part, upon the minimum sidewall thickness over the entire container. Thickness variation results in having areas within the same bottle where thickness is barely within the specification and areas where the thickness is substantially higher than the minimum specification (which is wasted material). Additional light weighting becomes possible when the variation between the thin and thick areas is reduced. Second, even circumferential wall thickness results in even strength of the container sidewalls, preventing ovalization when the container is subjected to stresses induced by post mold shrinkage or post hot-fill vacuum.

Third, bottles with thin and thick areas in the sidewalls give the consumer an impression of poor container quality. Fourth, during filling and distribution, the ability of containers to resist crushing force from above, commonly known as top load strength, is important for container and pallet integrity. When top load failures occur, the initial failure occurs at the weakest point of the container, which often corresponds to the point at which the container sidewall is thinnest. Uniformity of wall uses the container material more efficiently, i.e. higher top load strength can be attained in a container of similar weight when weak spots are diminished in the bottle sidewall. And finally, the transmission rate of gaseous matter is dependent upon the thickness of the barrier to be passed. Thus, thin sections of bottle wall will allow gases such as oxygen, nitrogen, and water vapor to pass the wall of the bottle at a higher rate than the thick sections.

In a one stage stretch blow molding process, uniformity of preform temperature in the circumferential direction is both a function of the uniformity of cooling at the injection stage as well as the ability of the machine to maintain that uniformity while preforms are conveyed from the injection mold to the blow mold. In a two stage process, since preforms are heated from ambient temperature, the reheat oven is for all practical purposes the only factor in preform temperature control, and thereby the most important factor in uniformity of circumferential wall thickness. It is typical for manufacturers of reheat stretch blow molding equipment to provide a means of adjusting the temperature of individual lamps in the oven in order to profile the temperatures along the height of the preform, since this is important for flexibility in preform and container design. In contrast, it is not customary to provide a means of minimizing the circumferential temperature gradient to a point that is sufficient to prevent large variation in wall thickness around the circumference of a polypropylene container. Furthermore, significant temperature gradients around the circumference of the preform cause asymmetrical development of the container during stretching and inflation inside the mold, often resulting severe off-quality situations such as blow-outs or base folds which reduce process reliability and diminish any assumed cost advantages. This situation can often be improved by reducing the speed of the blow molding machine, but this solution decreases profitability. Thus, those that wish to use polypropylene must often tolerate compromises despite a multitude of potential cost and performance advantages.

Modern two stage RSBM (reheat stretch blow molding) processes are designed to blow PET preforms into containers with acceptable circumferential wall thickness uniformity. Until the present invention, a process has not been found to provide polypropylene containers at high speeds and with circumferential thickness uniformity and process reliability comparable to the aforementioned PET process. A common belief in the industry is that the inherent inability of polypropylene to strain harden at elongations that are useful in RSBM severely limits the utility of the material in such applications. The present invention demonstrates that, given sufficient control of the temperature of the preform about its circumference, a polypropylene container of significantly improved quality can be produced at high speeds.

Disclosed is a process used for stretch-blow molding that produce polypropylene bottles at a rate of at least 1000 bottles per cavity per hour, or more preferably 1400 bottles per cavity per hour, more preferably 2000 bottles per cavity per hour.

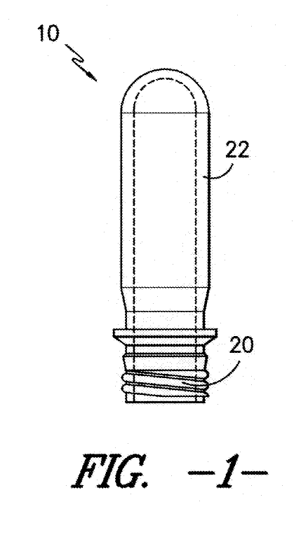

The process begins with forming a preform by injection molding. A typical preform for a polypropylene bottle may be found in FIG. 1. Preferably, the preform 10 has a wall thickness of between 2 and 4 millimeters. The preform 10 typically has a screw top section 20 and the main section 22. For the two-stage stretch-blow molding processes as this invention is directed towards, the injection molded preforms 10 are usually made on a separate machine (which may not even be at the same location as the stretch-blow molding machines), cooled to ambient temperature, and shipped over to the stretch-blow molding machines.

In the stretch-blow molding machine, the preform is first preheated. This preheating takes place by the preforms traveling on a belt between one or more banks of opposing IR heaters and reflectors. The reflectors are typically made of metal, preferably polished aluminum or steel, and have openings through which air passes to cool the outside of the preform, thereby preventing overheating of the preform surface as the infrared lamps heat the subsurface portions of the preform. The lamps consist of metallic filaments encased in hollow quartz tubes.

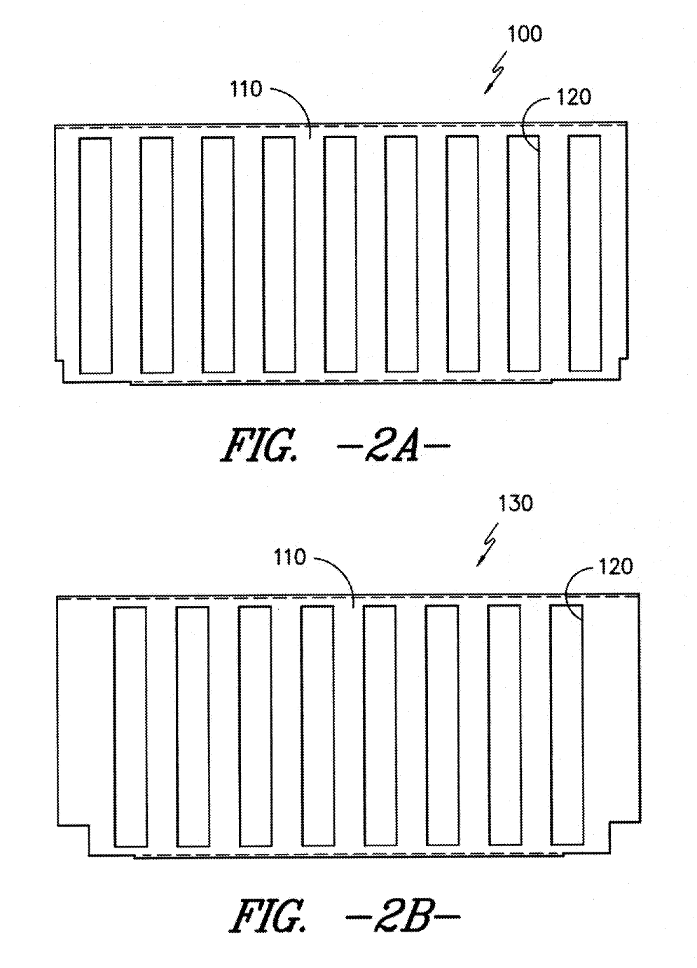

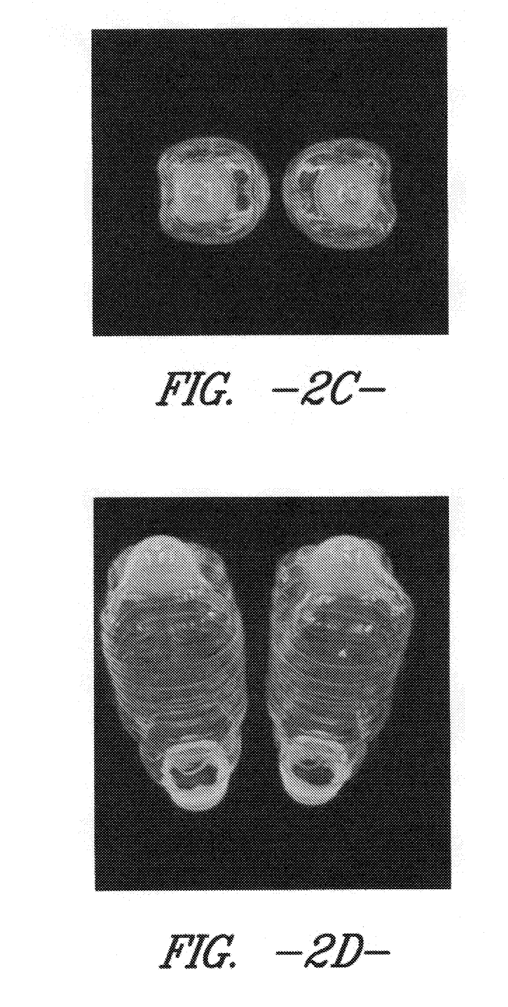

In prior art systems, the reflector design caused uneven heating of the preforms, causing uneven expansion when formed into a bottle in the blow molding section of the machine. FIG. 2A shows an example of a reflector 100 that causes uneven preheating. In this reflector, the reflective areas 110 have a width of 20 mm and the openings 120 have a width of 20 mm. A second reflector 130, shown in FIG. 2B is installed behind the first, with identical openings 120 which are offset by 20 mm in order to maximize reflective area 110 while still allowing air to pass. FIG. 2C shows an image of a partially inflated (preblow) blow molded bottle that was preheated by the reflector assembly of FIG. 2A-B. FIG. 2D shows an image of a fully inflated bottle that was preheated by the reflector in FIG. 2A. If the open regions 120 are too large relative to the circumference of the preform as shown, for example, in the reflector of FIG. 2A-B, the cooling effect of the air being forced through the open areas 120 and the heating effect of the infrared light reflected in the reflective areas 110 will cause large variation in preform temperature. In this specific example, the variation has 90-degree periodicity. This results similarly periodic wall thickness variation, as can be indicated by non-uniform hoop stretch in the preblow. A decrease in the width of the open areas 120 of the reflector relative to the preform circumference results in a smaller gradient in preform temperature around the circumference of the preform, resulting in improved wall thickness distribution.

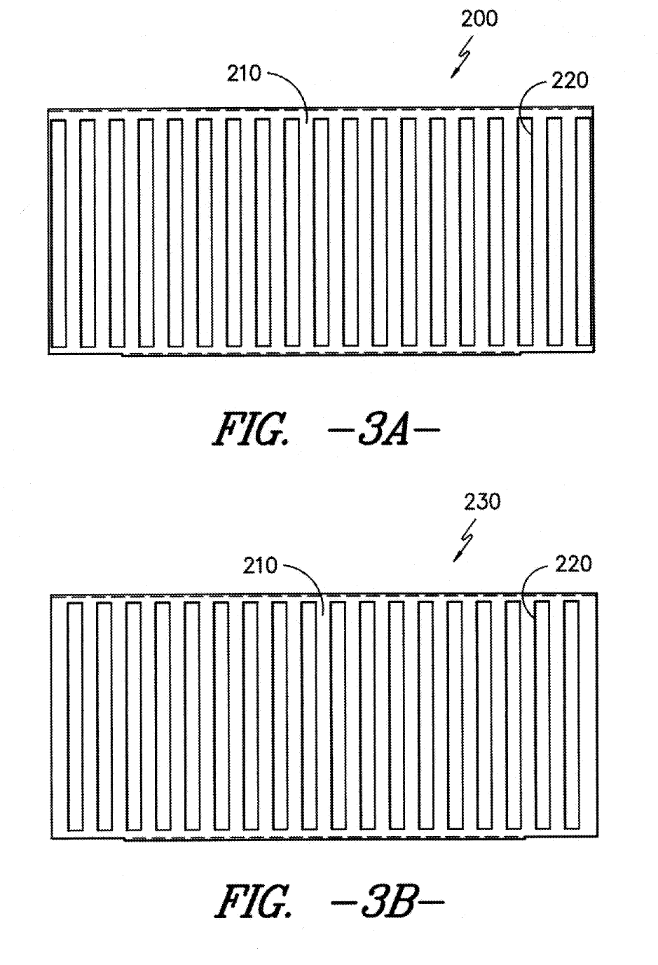

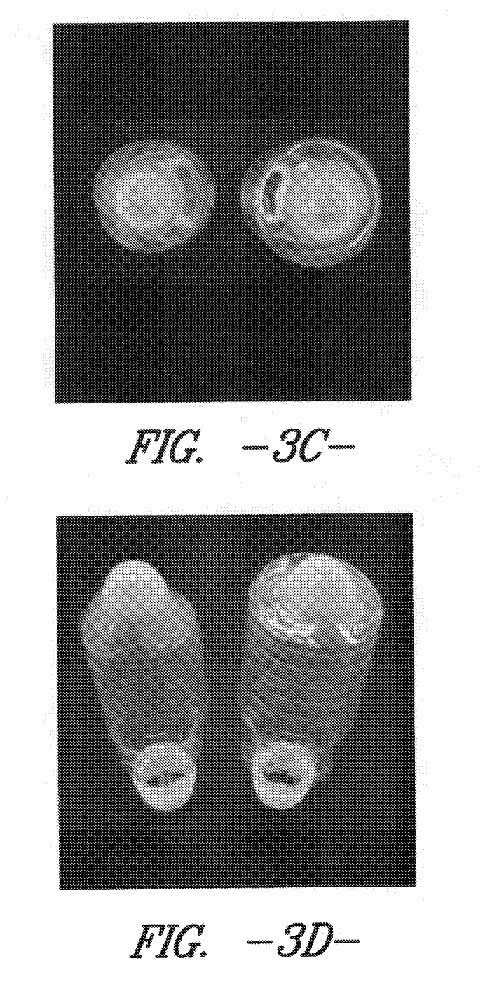

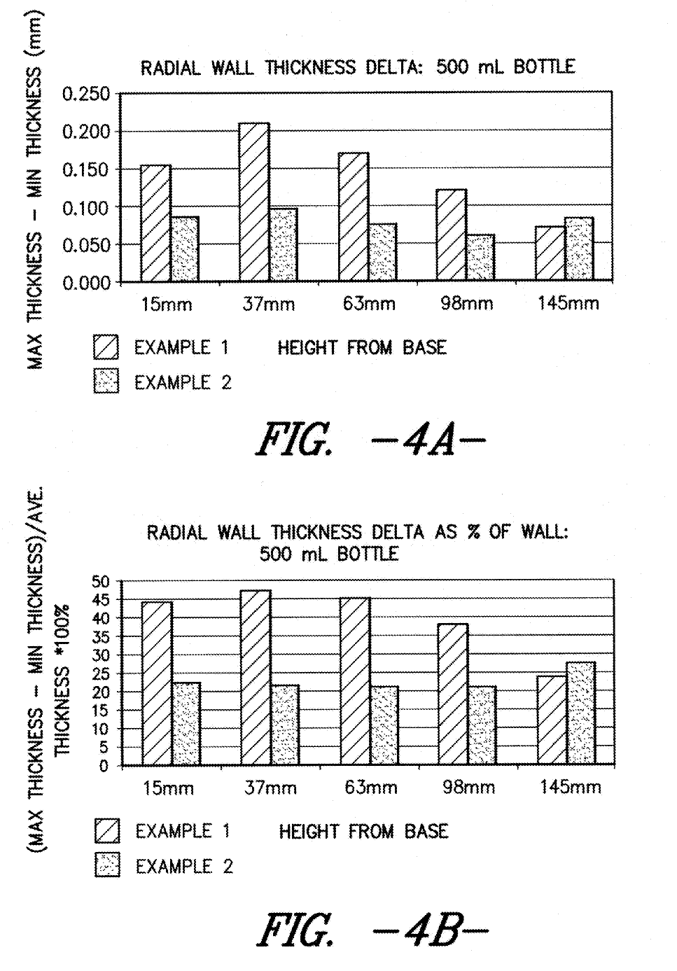

FIG. 3A shows an example of a reflector 200 that produces more even preheating. In this reflector, the reflective areas 210 have a width of 10 mm and the openings 220 have a width of 10 mm. A second reflector 230, shown in FIG. 3B is installed behind the first, with identical openings 220 which are offset by 10 mm in order to maximize reflective area 210 while still allowing air to pass. FIG. 3C shows an image of a partially inflated (preblow) blow molded bottle that was preheated by the reflector assembly of FIG. 3A-B. FIG. 3D shows an image of a fully inflated bottle that was preheated by the reflector in FIG. 3A. The reflectors shown in FIGS. 3A-B show an improvement in partially inflated and fully inflated bottles. This improvement has also been seen when using the reflectors of FIGS. 3A-B in the production of PET blow-molded bottles as well. Preferably, the surface area of the reflective regions 210 and the open regions 220 of the reflector 200 and 230 are in a 1:1 ratio. In one embodiment, the metallic regions have a width of between 5 and 15% of the circumference of the preform.

To reduce the variations in viscosity that lead to non-uniform hoop stretch of the preform, the circumference of the preform article should have a temperature delta of at most ten degrees Celsius, more preferably less than five degrees Celsius, more preferably less than two degrees Celsius, and more preferably less than one degree Celsius. In another embodiment, the temperature delta is less than 3.5 degrees.

Poor reflector design is not the only source of circumferential temperature variation that would result in poor wall thickness distribution in polypropylene containers. It is anticipated that insufficient rotational velocity of the preforms during reheat, regular periodicity of heating or cooling elements as they relate to the circumference of the preform, poor uniformity of airflow in the oven, air currents contacted by the preform between exit from the oven and placement in the blow mold, and metallic objects that contact the preform between the oven and placement in the blow mold may all contribute to poor uniformity of circumferential temperature. In typical PET blow molding machines and processes, these factors may have been diminished to the point of producing of quality PET containers. Due to the absence of the self-leveling effect known to occur during the blow molding of PET preforms, polypropylene preforms will stretch more easily and effectively without limit in areas of higher temperature. These areas stretch to the point of contacting the cool walls of the blow mold, at which point they quench, thereby forming thin areas in the container sidewall. In light of the improvement in quality observed with the present invention, it is anticipated that reducing or eliminating any source of non-uniformity of circumferential temperature in polypropylene preforms would result in an improved circumferential wall thickness distribution.

After completion of the reheat step of the process, the preforms are conveyed out of the oven and inserted into the cavity of a stretch blow molded machine and formed (blown) into a bottle. The resultant bottle of this process has a wall thickness delta (maximum thickness−minimum thickness) at any given height along the bottle of less than 30% of the average wall thickness at a given height, more preferably 20%, and more preferably 10%. In another embodiment, the wall thickness delta at any given height is less than 35%.

Polypropylene has long been known to exist in several forms, and essentially any known form could be used in the practice of the invention. Thus, the invention is not limited to any particular type of polypropylene. Isotactic propylene (iPP) may be described as having the methyl groups attached to the tertiary carbon atoms of successive monomeric units on the same side of a hypothetical plane through the polymer chain, whereas syndiotactic polypropylene (sPP) generally may be described as having the methyl groups attached on alternating sides of the polymer chain. The polypropylene polymers employed in the practice of the invention may include homopolymers (known as HPs), impact or block copolymers (known as ICPs) (combinations of propylene with certain elastomeric additives, such as rubber, and the like), and random copolymers (known as RCPs) made from at least one propylene and one or more ethylenically unsaturated comonomers. Generally, co-monomers, if present, constitute a relatively minor amount, i.e., about 10 percent or less, or about 5 percent or less, of the entire polypropylene, based upon the total weight of the polymer. Such co-monomers may serve to assist in clarity improvement of the polypropylene, or they may function to improve other properties of the polymer. Co-monomer examples include acrylic acid and vinyl acetate, polyethylene, polybutylene, and other like compounds.

Polypropylene provides an average molecular weight of from about 10,000 to about 2,000,000, preferably from about 30,000 to about 300,000, and it may be mixed with additives such as polyethylene, linear low density polyethylene, crystalline ethylenepropylene copolymer, poly(1-butene), 1-hexene, 1-octene, vinyl cyclohexane, and polymethylpentene, as examples. Other polymers that may be added to the base polypropylene for physical, aesthetic, or other reasons, include polyethylene terephthalate, polybutylene terephthalate, and polyamides, among others. In one embodiment the polypropylene bottle comprises polypropylene homopolymers. These homopolymers provide properties that are desirable in a container, such as increased stiffness and heat resistance versus random copolymers. The effects of preform circumferential temperature gradients are sometimes much more apparent in containers formed from this material. The present invention provides a means of improving the quality of homopolypropylene reheat stretch blow molded containers. In another embodiment, the polypropylene bottle comprises metallocene polypropylene.

In one embodiment, the polypropylene bottle comprises a nucleating agent. An effective nucleator, for polypropylene is 1,3-O-2,4-bis(3,4-dimethylbenzylidene) sorbitol (hereinafter DMDBS), available from Milliken & Company under the trade name Millad® 3988. Such a compound provides highly effective haze reductions within polypropylenes with concomitant low taste and odor problems. An effective thermoplastic nucleator in terms of high crystallization temperatures is available from Milliken & Company using the tradename HPN-68™. Other like thermoplastic nucleating compounds that may be employed in the practice of the invention are disclosed in U.S. Pat. Nos. 6,465,551 and 6,534,574. The HPN-68™ compound is disodium bicyclo[2.2.1]heptanedicarboxylate. The ability to provide highly effective crystallization, or, in this specific situation, control targeted levels of crystallization within polypropylene preforms prior to injection stretch blow molding sometimes is facilitated by utilization of such a nucleating agent. Low amounts of this additive can be provided to produce the desired and intended amorphous-crystalline combination within the target preforms.

Other nucleating agents can be employed in the practice of the invention. These include dibenzylidene sorbitol compounds (such as unsubstituted dibenzylidene sorbitol, or DBS, and p-methyldibenzylidene sorbitol, or MDBS), sodium benzoate, talc, and metal salts of cyclic phosphoric esters such as sodium 2,2′-methylene-bis-(4,6-di-tert-butylphenyl) phosphate (from Asahi Denka Kogyo K.K., known as NA-11), and cyclic bis-phenol phosphates (such as NA-21®, also available from Asahi Denka), metal salts (such as calcium) of hexahydrophthalic acid, and, as taught within Patent Cooperation Treaty Application WO 98/29494, to 3M, the unsaturated compound of disodium bicyclo[2.2.1]heptene dicarboxylate. Such compounds all impart relatively high polypropylene crystallization temperatures.

Commercially available products suitable for use in the practice of the present invention include not only Millad® 3988 (3,4-dimethyldibenzylidene sorbitol) mentioned above, but also NA-11® (sodium 2,2-methylene-bis-(4,6, di-tert-butylphenyl)phosphate, available from Asahi Denka Kogyo, aluminum bis[2,2′-methylene-bis-(4,6-di-tert-butylphenyl)phosphate], known commercially as NA-21®, also available from Asahi, Ciba® Irgaclear® XT 386 (1,3,5-tri(dimethylisopropoylamino)benzene) described in WO2004/072168A2 and Rikaclear® PC1 (N,N′,N″-tris[2-methylcyclohexyl]-1,2,3-propanetricarboxamide) described in WO2005/037770A1. The following nucleating agents could be used in the practice of the invention: sodium 1,3-O-2,4-bis(4-methylbenzylidene) sorbitol and derivatives thereof: 1,2-cyclohexanedicarboxylate salts and derivatives thereof; aluminum 4-tert-butylbenzonate and derivatives thereof; and metal salts of cyclic phosphoric esters and derivatives thereof. Furthermore, one advantageous nucleating agent compound for use in injection stretch blow molding as disclosed herein is a dibenzylidene sorbitol-based (“DBS”) compound having a substituted R group on the terminal carbon of the sorbitol chain, as disclosed for example in U.S. Pat. No. 7,157,510 and United States Patent Publication 2005/0239928.

Nucleating agents, clarifying agents, HHPA and/or bicyclic salts may be added to polypropylene in an amount from about 0.01 percent to about 10 percent by weight. In most applications, however, less than about 5.0 percent by weight of such nucleating agents are needed. In other applications, such compounds may be added in amounts from about 0.02 to about 3.0 percent. Some applications will benefit from a concentration of about 0.05 to 2.5 percent, to provide beneficial characteristics (1.0% by weight equals about 10,000 ppm).

### EXAMPLES

### Comparison Example 1

Example 1 is the comparison example where the preheating section of the Sidel Series Two SBO-4 stretch-blow molding machine had four of the reflector assemblies shown in FIG. 2A. These reflectors were 0.80 mm thick and made from polished aluminum. As installed, the face of the front reflector was 373 mm wide and 169 mm high. It had 20 mm wide by 155 mm high rectangular holes, spaced 20 mm apart and centered vertically. The second reflector had similar overall dimensions and identical holes which were offset 20 mm relative to the holes in the front reflector, and were installed approximately 3 mm behind the first.

Preforms weighing 21 grams and having a 38 mm neck finish were injection molded from a polypropylene random copolymer of an approximate melt flow rate of 25 g/10 min and loaded to be blown in one blow mold at 1600 bottles per cavity per hour. In the penetration ovens, both lamps were activated for zones 1, 2, 4, 5, and 6, only lamp one was activated in zone three, and only lamp two was activated in zone one. In the distribution oven the profile used was 72%, 75%, 67%, 70%, 55%, 55%, 55% from zone 1 to zone 7. Throughout the production, general oven power was controlled at 60%. Preblow pressure was 2.4 bar, and blow pressure was 16.5 bar. The blow molds were cooled with water supplied at 10° C.

### Invention Example 2

Example 2 is the invention example where the preheating section of the Sidel Series Two SBO-4 stretch-blow molding machine had four of the reflector assemblies shown in FIG. 3A. These reflectors were 1.11 mm thick and made from polished stainless steel. As installed, the face of the front reflector was 373 mm wide and 169 mm high. It had rectangular holes 10 mm wide by 155 mm high rectangular holes, spaced 10 mm apart and centered vertically. The second reflector had similar overall dimensions and identical holes which were offset 10 mm relative to the holes in the front reflector, and were installed approximately 3 mm behind the first.

The preforms used were identical to those used in Comparison Example 1. They were loaded to be blown in one blow mold at 1600 bottles per cavity per hour. In the penetration ovens, both lamps were activated for zones 1, 2, 4, 5, and 6, only lamp one was activated in zone three, and only lamp two was activated in zone one. In the distribution oven the profile used was 97%, 98%, 67%, 70%, 62%, 64%, 60% from zone 1 to zone 7. Because the reflectors change the flow of air over the preforms, as well as the reflection of infrared energy, it was necessary to adjust the process in order to keep the preform temperature within the polypropylene blowing window. Throughout the production, general oven power was controlled at 60%. Preblow pressure was 2.4 bar, and blow pressure was 16.5 bar. The blow molds were cooled with water supplied at 10° C.

FIG. 2C shows images of partially inflated bottles produced using Comparison Example 1. FIG. 2D shows images of fully inflated bottles produced using Comparison Example 1. FIG. 3C shows images of partially inflated (preblow) bottles produced using Invention Example 2. FIG. 3D shows images of fully inflated bottles produced using Invention Example 2. As can be seen from the images, the bottles produced using the invention reflector are more evenly developed.

FIG. 6 shows thermal images of preforms that were extracted from the oven track after the reheating. The images were recorded using a Thermovision A40M from FLIR Systems. Emissivity was set to 0.95. Preforms from Comparative Example 1 show temperature gradients that are sharper than those of Invention Example 2.

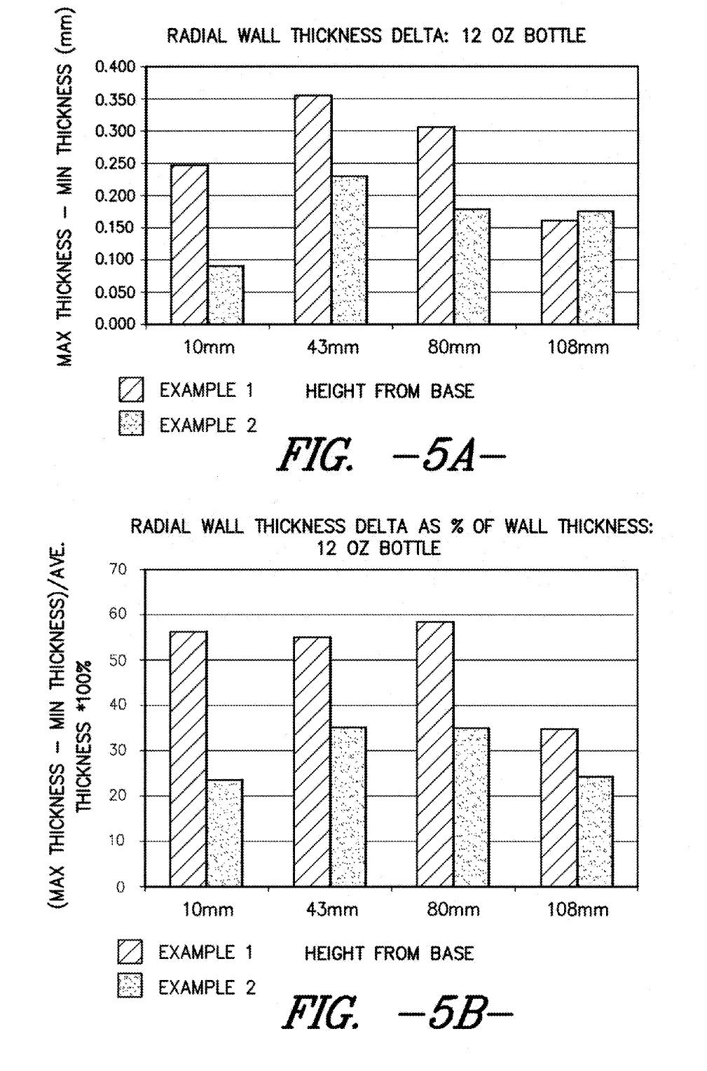

FIGS. 4A and 4B show the thickness deltas and thickness deltas as a percentage of average wall thickness versus height of bottles for 500 ml polypropylene bottles produced at 1600 bottles per cavity per hour. As can been seen from FIG. 4A, the wall thickness delta (the maximum wall thickness minus the minimum wall thickness at a given height) versus height along the bottle is significantly smaller for the Invention Example 2 compared to the Comparison Example 1. FIG. 4B shows the wall thickness delta as a percentage of the average wall thickness versus height. Invention Example 2 shows a much smaller percentage than the Comparison Example 1.

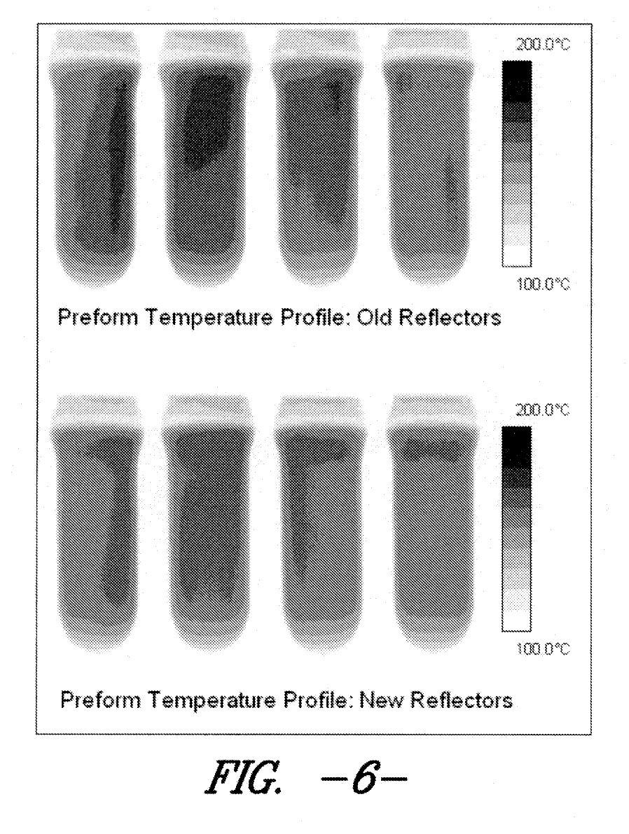

FIGS. 5A and 5B show the same test results as 4A and 4B respectively for a 12 ounce bottle. Invention Example 2 has significantly smaller thickness deltas and thickness deltas as a percentage of average wall thickness. Because the Invention Example 2 bottles have a more even circumferential wall thickness, the bottles have a advantages over the uneven walled Example 1 bottles.

### Examples 3-13

In the examples 3-13 (comparison and invention examples), preforms were prepared on a Husky S90 injection molder and were free from flow lines and thickness non-uniformity. Injection conditions were controlled to avoid molded-in orientation in order to produce clear bottles without haze. The preforms were at room temperature prior to entry into the reheat oven. The preform designs used are described in the following Table 1. Orientable height is defined as the length of a line drawn on the preform sidewall from below the support flange of the preform to the gate vestige. The circumference of the orientable section was measured at a point in the center of the preform sidewall and represents the circumference of the majority of the sidewall.

TABLE 1
Preform designs used in the Examples 3-13

| | | | Max. Wall | Circum- | | |
|---|---|---|---|---|---|---|
| | | | Thickness | ference | | |
| | | | of | of | | |
| Pre- | Neck | | Orientable | Orientable | Orientable | |
| form | Size | Polymer | Section | Section | Height | Weight |
| A | 38 mm | PP | 2.8 mm | 91 mm | 86 mm | 21 g |
| B | 38 mm | PP | 2.0 mm | 91 mm | 86 mm | 17 g |
| C | 38 mm | PET | 3.0 mm | 77 mm | 65 mm | 27 g |

The bottle types prepared for the examples are listed below in Table 2.

TABLE 2
Bottle types used in Examples 3-13

| | | | Largest | Orientation |
|---|---|---|---|---|
| Bottle | Type | Volume | Circumference | Height |
| D | Cold Fill | 500 ml | 250 mm | 210 mm |
| E | Panelled | 355 ml | 250 mm | 165 mm |

Example bottles were prepared on a Sidel rotary blow molding machine using one blow cavity and four oven units. Machine output was set to the maximum of 1600 bottles per hour, per cavity. The blow molds were cooled with glycol that was circulated at 20° C. Preforms were rotated per standard machine design while advancing through the ovens. Depending upon the preform, either six or seven parallel and vertically-spaced infrared lamps per oven unit were used. In cases where seven lamps were employed, the lamp farthest from the neck finish [L7] was positioned above the end cap of the preform. Lamp 1 [L1] was immediately adjacent to the area of the preform body closest the support ledge. L1-L7 percentages are the power percentages of the individual lamps. The conditions used during stretch blow molding are shown in the following Table 3. Orientation height is the length of a line drawn on the bottle sidewall from a point below the support flange to the injection gate vestige.

TABLE 3
Stretch blow molding conditions for Examples 3-13

| | Example | | | | | | | | | | |
|---|---|---|---|---|---|---|---|---|---|---|---|
| | 3 | 4 | 5 | 6 | 7 | 8 | 9 | 10 | 11 | 12 | 13 |
| L7%(over- | 48 | 43 | 39 | 42 | 42 | 50 | 54 | 28 | 26 | N/A | N/A |
| hanging) | | | | | | | | | | | |
| L6% | 70 | 69 | 64 | 64 | 64 | 73 | 77 | 73 | 71 | 69 | 69 |
| L5% | 72 | 69 | 66 | 64 | 64 | 73 | 79 | 77 | 71 | 41 | 41 |
| L4% | 71 | 66 | 66 | 68 | 68 | 44 | 46 | 36 | 32 | 37 | 37 |
| L3% | 44 | 48 | 40 | 39 | 39 | 50 | 52 | 37 | 36 | 39 | 39 |
| L2% | 77 | 73 | 73 | 77 | 77 | 73 | 75 | 69 | 69 | 50 | 50 |
| L1% | 74 | 72 | 70 | 79 | 79 | 73 | 75 | 74 | 75* | 80* | 80* |
| General | 60 | 60 | 50 | 61 | 61 | 70 | 77 | 75 | 70 | 70 | 70 |
| Power | | | | | | | | | | | |
| Scaling % | | | | | | | | | | | |
| Ventilation | 95 | 95 | 95 | 95 | 95 | 90 | 90 | 90 | 90 | 70 | 70 |
| % | | | | | | | | | | | |
| Pre-blow | 2.4 | 2.4 | 2.4 | 2.4 | 2.4 | 2.0 | 2.0 | 2.0 | 2.0 | 6.0 | 6.0 |
| Pressure | | | | | | | | | | | |
| (bar) | | | | | | | | | | | |
| High Press. | 16 | 16 | 16 | 16 | 16 | 16 | 16 | 40 | 40 | 16 | 16 |
| Blow (bar) | | | | | | | | | | | |
| Preblow | 0.30 | 0.30 | 0.30 | 0.30 | 0.30 | 0.20 | 0.20 | 0.20 | 0.20 | 0.06 | 0.06 |
| Time (s) | | | | | | | | | | | |
| High press. | 0.77 | 0.77 | 0.77 | 0.76 | 0.77 | 0.87 | 0.87 | 0.86 | 0.86 | 0.88 | 0.88 |
| blow time | | | | | | | | | | | |
| (s) | | | | | | | | | | | |

*A quartz lens was used to facilitate distribution of material from below the support ledge into the bottle sidewall.

In order to measure circumferential reheat uniformity, a Thermavision A40 infrared camera, provided by FLIR Systems, Inc, Billerica, Mass., was used to record preforms advancing out of the reheat oven immediately prior to blowing. During this advancement, the preforms were still rotating. The presence of a more rapidly changing temperature gradient was observed in the preforms reheated employing the prior art reflectors. In order to provide a quantitative measure of the reheat uniformity improvement, the recordings were advanced frame-by-frame and the minimum and maximum temperatures about the preform circumference in an area immediately below the preform end cap were determined.

### Comparative Example 3

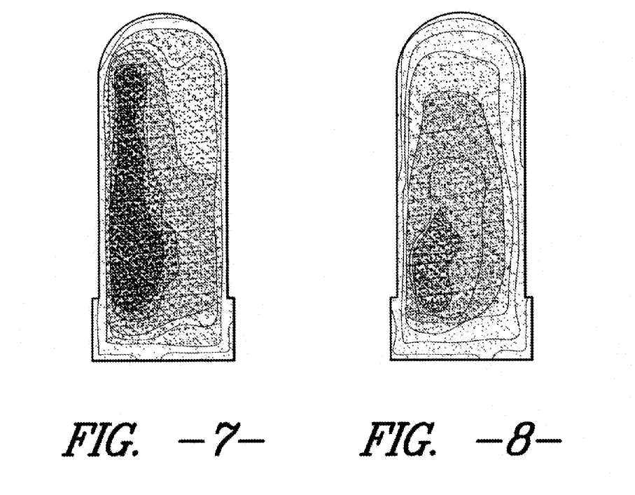

Room-temperature preforms of type A above, made from a random propylene ethylene copolymer of about 25 melt flow rate, were fed into a Sidel SBO-4 running at 1600 bottles per cavity, per hour. Prior art reflectors were installed in the reheat ovens. A recording of the preforms exiting the ovens was made with a FLIR Systems A40. These same preforms were blown into the type D bottle described above. Extreme non-uniformity in local temperatures of individual preforms was observed as the preforms rotated upon exiting the oven. The recording was analyzed with FLIR Systems ThermaCAM Researcher Pro version 2.8, using spot meters to determine the maximum and minimum preform temperature in a portion of the preform sidewall immediately adjacent to the end cap. The difference between minimum and maximum temperature for an individual preform was calculated. Ten preforms were analyzed in this way and the average difference between the minimum and maximum preform temperatures was recorded as a Circumferential Temperature Delta of 5.4° C. also shown graphically in FIG. 7. The wall thicknesses of bottles blown in same lot were measured with a Magna Mike 8500. Thickness was measured at eight equidistant circumferential points at five different heights on each bottle. Thickness Range for each height was recorded as a percentage of the average thickness at the same height, or
(maximum thickness−minimum thickness)/average thickness*100%.

The Maximum Thickness Range was found to be 95% of the average thickness, in other words, the estimated range of thickness was nearly as large as the average thickness.

### Invention Example 4

Preforms were reheated and bottles were blown under conditions similar to those on Comparative Example 3, except using the reflectors of the present invention in order to minimize circumferential temperature variation. To facilitate comparison, analysis was performed identically to Comparative Example 3. Under these conditions, the Circumferential Temperature Delta was found to be 1.9° C. and the Maximum Thickness Range was only 28% of the average thickness. This is shown graphically in FIG. 8. Thus, it is shown that when careful attention is devoted to minimizing Circumferential Temperature Delta after reheating preforms, the resultant bottles are more uniformly distributed.

### Examples 5-13

Similar analysis was performed on a variety of preforms, bottles, and materials shown as examples 5-13. These examples are disclosed in the following table.

TABLE 4
Examples 3-13 processing conditions

| | | Approximate | | | |
|---|---|---|---|---|---|
| | | Resin MFR | Preform | Bottle | Reflector |
| Example | Resin Type | (g/10 min) | Design | Design | Design |
| Comp. 3 | PP Random | 25 | A | D | Prior art |
| | Copolymer | | | | |
| Inv. 4 | PP Random | 25 | A | D | Invention |
| | Copolymer | | | | |
| Inv. 5 | PP Random | 10 | A | D | Invention |
| | Copolymer | | | | |
| Inv. 6 | PP Random | 10 | A | D | Invention |
| | Copolymer | | | | |
| Comp. 7 | PP Random | 10 | A | D | Prior art |
| | Copolymer | | | | |
| Comp. 8 | PP Random | 25 | A | E | Prior art |
| | Copolymer | | | | |
| Inv. 9 | PP Random | 25 | A | E | Invention |
| | Copolymer | | | | |
| Comp. 10 | Bottle Grade | N/A | C | D | Prior art |
| | PET | | | | |
| Comp. 11 | Bottle Grade | N/A | C | D | Invention |
| | PET | | | | |
| Comp. 12 | PP Random | 30 | B | E | Prior art |
| | Copolymer | | | | |
| Inv. 13 | PP Random | 30 | B | E | Invention |
| | Copolymer | | | | |

TABLE 5
Examples 3-13 bottle results

| | Circumferential | Average Bottle | Maximum |
|---|---|---|---|
| | Temperature | Thickness at Max | Thickness Range |
| Example | Delta (° C.) | Delta Height (mm) | (% of Average) |
| Comp. 3 | 5.4 | 0.24 | 95 |
| Inv. 4 | 1.9 | 0.34 | 28 |
| Inv. 5 | 2.9 | 0.38 | 34 |
| Inv. 6 | 2.6 | 0.30 | 35 |
| Comp. 7 | 5.4 | 0.38 | 101 |
| Comp. 8 | 4.6 | 0.36 | 105 |
| Inv. 9 | 2.7 | 0.63 | 31 |
| Comp. 10 | 5.7 | 0.22 | 18 |
| Comp. 11 | 2.7 | 0.26 | 12 |
| Comp. 12 | 3.8 | 0.32 | 106 |
| Inv. 13 | 2.1 | 0.33 | 37 |

As can be seen from the results of Table 5, it is demonstrated that the prior art process is capable of producing PET bottles with relatively small circumferential wall thickness variation, even under conditions which induce higher variation in local preform temperature. Indeed, even substantial improvements in preform temperature uniformity result in marginal wall thickness uniformity improvements when PET preforms are used. In contrast, careful control of temperature variation about the preform is critical to minimizing the wall thickness variation in the final bottle when polyolefin preforms are utilized. The invention reflector significantly reduces the circumferential temperature delta and the maximum thickness range in polypropylene bottles.

The invention has been described in detail with particular reference to certain preferred embodiments thereof, but it will be understood that variations and modifications can be effected within the spirit and scope of the invention.

What is claimed is:

1. A process for producing polypropylene bottles comprising:
forming a polypropylene preform having a generally cylindrical shape with a height and a circumference;
cooling the polypropylene preform;
preheating the preform, wherein the temperature at positions around the circumference of the preform have a temperature delta of less than 5 degrees Celsius at any height along the preform;
inserting the preheated preform into a cavity of a stretch blow molding machine; and,
stretch blow molding the preform into a polypropylene bottle at a rate of at least 1000 bottles per cavity per hour, said bottle having a sidewall and a height, the bottle having a circumference defined by said sidewall, wherein the polypropylene bottle has a wall thickness delta at any given height along the circumference of the bottle of less than 30% of the average wall thickness at the given height.

2. The process of claim 1, wherein the polypropylene bottle has a wall thickness delta at any given height along the bottle of less than 20% of the average wall thickness at the given height.

3. The process of claim 1, wherein the temperature around the circumference of the preform article has a temperature delta of less than five degrees Celsius at any height along the preform.

4. The process of claim 1, wherein the temperature around the circumference of the preform article has a temperature delta of less than two degrees Celsius at any height along the preform.

5. The process of claim 1, wherein the temperature around the circumference of the preform article has a temperature delta of less than one degrees Celsius at any height along the preform.

6. The process of claim 1, wherein the polypropylene preform has a wall thickness of between 2 and 4 millimeters.

7. The process of claim 1, wherein the polypropylene preform comprises a nucleating agent.

8. The process of claim 1, wherein the polypropylene bottle comprises polypropylene homopolymers.

9. The process of claim 1, wherein the polypropylene bottle comprises metallocene polypropylene.

10. The process of claim 1, wherein preheating the preform comprises the preform passing between an IR source and a reflector.

11. The process of claim 10, wherein the reflector has metallic regions and openings between the metallic regions, and wherein air is passed through the openings towards the preforms.

12. The process of claim 11, wherein the ratio of the surface areas of the metallic regions and openings is approximately 1:1.

13. The process of claim 11, wherein the metallic regions have a width of between 5% and 15% of the circumference of the preform.

14. The process of claim 1, wherein the stretch blow molding the preform into a polypropylene bottle is at a rate of at least 1400 bottles per cavity per hour.

15. A process for producing polypropylene bottles comprising:
forming a polypropylene preform having a generally cylindrical shape with a height and a circumference;
cooling the polypropylene preform;
preheating the preform by passing the preform between an IR source and a reflector, wherein the reflector has metallic regions and openings between the metallic regions, wherein air is passed through the openings towards the preforms, wherein the ratio of the surface areas of the metallic regions and openings is approximately 1:1, wherein the metallic regions have a width of between 5% and 15% of the circumference of the preform and wherein the temperature at positions around the circumference of the preform have a temperature delta of less than 5 degrees Celsius at any height along the preform;
inserting the preheated preform into a cavity of a stretch blow molding machine; and,
stretch blow molding the preform into a polypropylene bottle at a rate of at least 1000 bottles per cavity per hour, said bottle having a sidewall and a height, the bottle having a circumference defined by said sidewall, wherein the polypropylene bottle has a wall thickness delta at any given height along the circumference of the bottle of less than 30% of the average wall thickness at the given height.

16. A polypropylene bottle produced by the process comprising:
forming a polypropylene preform having a generally cylindrical shape with a height and a circumference;
cooling the polypropylene preform;
preheating the preform, wherein the temperature at positions around the circumference of the preform have a temperature delta of less than 5 degrees Celsius at any height along the preform;
inserting the preheated preform into a cavity of a stretch blow molding machine; and,
stretch blow molding the preform into a polypropylene bottle at a rate of at least 1000 bottles per cavity per hour, said bottle having a sidewall and a height, the bottle having a circumference defined by said sidewall, wherein the polypropylene bottle has a wall thickness delta at any given height along the circumference of the bottle of less than 30% of the average wall thickness at the given height.

17. The bottle of claim 16, wherein preheating the preform comprises passing the preform between an IR source and a reflector, wherein the reflector has metallic regions and openings between the metallic regions, wherein air is passed through the openings towards the preforms, wherein the ratio of the surface areas of the metallic regions and openings is approximately 1:1, wherein the metallic regions have a width of between 5% and 15% of the circumference of the preform.

18. The bottle of claim 16, wherein the polypropylene bottle has a wall thickness delta at any given height along the bottle of less than 20% of the average wall thickness at the given height.

19. The bottle of claim 16, wherein the temperature around the circumference of the preform article has a temperature delta of less than five degrees Celsius at any orientable height.

20. The bottle of claim 16, wherein the temperature around the circumference of the preform article has a temperature delta of less than two degrees Celsius at any orientable height.

21. A 2-stage reheat stretch blow molding machine producing at least 1000 bottles per cavity per hour comprising:
a reheat section, a blowing section, and a plurality of preforms, wherein the reheat section comprises a plurality of infrared energy sources, at least 2 reflectors, and circulated air,
wherein the reflectors have metallic regions and openings between the metallic regions, wherein air is passed through the openings towards the preforms, wherein the ratio of the surface areas of the metallic regions and openings is approximately 1:1, wherein the metallic regions have a width of between 5% and 15% of the circumference of the preform and wherein the temperature at positions around the circumference of the preform have a temperature delta of less than 5 degrees Celsius at any height along the preform.
